(19) United States
(12) Patent Application Publication
(10) Pub. No.: US 2026/0194691 A1
(43) Pub. Date: Jul. 9, 2026

(54) LIGHT SHAPING OPTICAL DEVICE

(71) Applicant: VIAVI Solutions Inc., Chandler, AZ (US)

(72) Inventors: Jaroslaw Zieba, Santa Rosa, CA (US); Joerg Buth, Santa Rosa, CA (US)

(73) Assignee: VIAVI Solutions Inc., Chandler, AZ (US)

(21) Appl. No.: 19/441,783

(22) Filed: Jan. 6, 2026

Related U.S. Application Data
(60) Provisional application No. 63/742,846, filed on Jan. 7, 2025.

(51) Int. Cl. G02B 1/04; G02B 1/10; G02B 3/00; G02B 3/08; G02B 5/02

(52) U.S. Cl. CPC G02B 1/04; G02B 1/10; G02B 3/0012; G02B 3/0043; G02B 3/08; G02B 5/0268

(57) ABSTRACT

An optical device may include a light shaping optical element. The light shaping optical element may include a substrate having a shear modulus greater than 15 GPa. The light shaping optical element may include a film chemically bonded to the substrate by a chemical bonding layer having a thickness in a range of 0.1 µm and 20 µm. The film may include a polymer having a refractive index greater than 1.5. A surface, of the film, may include a plurality of features configured to interact with light. The film may have a thickness of greater than 15 µm.

### CROSS-REFERENCE TO RELATED APPLICATION

This Patent Application claims the benefit of U.S. Provisional Patent Application No. 63/742,846, filed on January 7, 2025, and entitled “LIGHT SHAPING OPTICAL DEVICE.” The disclosure of the prior-filed provisional application is considered part of and is incorporated by reference into this Patent Application.

### BACKGROUND

Optical devices can be used to control the trajectory of light. For example, light can undergo different transformations such as reflection, transmission, scattering, refraction and diffraction.

### SUMMARY

Some implementations described herein relate to an optical device. The optical device may include a light shaping optical element. The light shaping optical element may include a substrate having a shear modulus greater than 15 GPa. The light shaping optical element may include a film chemically bonded to the substrate by a chemical bonding layer having a thickness in a range of 0.1 µm and 20 µm. The film may include a polymer having a refractive index greater than 1.5. A surface, of the film, may include a plurality of features configured to interact with light. The film may have a thickness of greater than 15 µm.

Some implementations described herein relate to a wafer structure. The wafer structure may include a substrate. The wafer structure may include a film chemically bonded to the substrate by a chemical bonding layer. The film may include a polymer having a refractive index greater than 1.5. A surface of the film may include a plurality of features configured to interact with light.

Some implementations described herein relate to a method. The method may include providing a wafer substrate. The method may include chemically bonding a film to the wafer substrate using a chemical bonding layer to obtain a wafer structure. The film may include a polymer having a refractive index greater than 1.5. The method may include texturing the film to form a plurality of features configured to interact with light. The method may include dicing the wafer structure into a plurality of light shaping optical elements.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIGS. 1A and 1B are cross-sectional views of an example optical device.

FIG. 2 is a perspective view of an example wafer structure.

FIG. 3 is a flowchart of an example process associated with manufacturing a light shaping optical device.

FIG. 4 illustrates a chemical bonding step of the example process associated with manufacturing a light shaping optical device.

FIGS. 5A, 5B, and 5C illustrate a texturing step of the example process associated with manufacturing a light shaping optical device.

FIG. 6 shows example scanning electron microscopy (SEM) images of surface textures.

FIG. 7 illustrates a dicing step of the example process associated with manufacturing the light shaping optical device.

FIGS. 8A, 8B, and 8C illustrate a dicing step of the example process associated with manufacturing the light shaping optical device.

FIG. 8D illustrates top views of an unpatterned die and a patterned die.

FIG. 9 illustrates results from high temperature and high humidity reliability tests of dies.

FIG. 10 illustrates results from a solder reflow test of dies.

Like reference numbers and designations in the various drawings indicate like elements for purposes of ease of description.

### DETAILED DESCRIPTION

The following detailed description of example implementations refers to the accompanying drawings. The same reference numbers in different drawings may identify the same or similar elements.

Light shaping optics (LSO) can be used to control the spatial intensity distribution of light. They can be used for various applications, such as micro-lenses, diffraction elements, polarization state controlling devices, and optical diffusers to manage the shape and intensity of a laser beam. The refractive index (RI) is an important property of light shaping optics.

Polymers, especially polymers having a high refractive index, can be used to create textured surfaces that can be used to control light (e.g., the spatial intensity distribution of light). One approach, to increasing the refractive index of the polymer material is to load a host polymer with nanoparticles (e.g., TiO₂ nanoparticles) having a high refractive index. This approach can be one form of the polymer on glass (PoG) approach. However, with this approach, it may be difficult to control the distribution of the nanoparticles. This can lead to agglomeration of nanoparticles, which can cause problematic light scattering and prevent light from being controlled in a desired manner, thereby limiting the spectral wavelength range of the light. Additionally, there may be fundamental limitations for the loading capacity of nanoparticles into the host polymer. The mechanical robustness of the host polymer may also be compromised by high levels of nanoparticle loading. For example, inorganic materials (e.g., titanium dioxide, zirconium dioxide), used to increase the refractive index of the polymer material, can cause the polymeric network to become disrupted, which can lead to embrittlement of the polymeric material.

Furthermore, this approach often involves curing a liquid polymer on a rigid substrate to form a polymeric layer on the substrate. Undesirable stresses can be introduced at the interface between the polymeric layer and the substrate during the transition of the polymer from a liquid state to a solid state due to the change in volume of the polymeric layer. This stress is the main root cause of product failure seen during thermal cycling in certain PoG LSO elements such as engineered light diffusers made with liquid photopolymers. As a result of the transition, stresses can be localized at the interface between the polymeric layer and the substrate. Dicing a wafer that includes the resulting polymeric layer on the substrate into individual dies can introduce points along the dicing plane whereby the stress at the interface is released. This can lead to defects (e.g., cracks or fractures) that propagate within the dies and lead to breakage, which can affect the optical properties of the light shaping optical devices in a undesirable way. Furthermore, these defects can decrease the manufacturing yield of dies that have the desired light shaping function.

Some implementations described herein relate to a light shaping optical element that includes a foil made of a high refractive index material (e.g., polymer with RI greater than 1.5) chemically bonded to a rigid substrate (e.g., with a shear modulus greater than 15 GPa). These light shaping optical elements may be configured to provide the desired/limited spectral wavelength range of light without introducing undesirable stresses when a wafer is diced into the individual light shaping optical elements.

Light shaping optical devices can include one or more light shaping optical elements. The light shaping optical element can include a polymeric foil chemically bonded to the substrate. The light shaping optical element can include a rigid optical substrate with a chemically bonded thin foil of high refractive index polymer (e.g., a polymer having a refractive index of greater than 1.5) acting as an optically active layer.

The systems and methods of the present disclosure can expand access to new classes of optical materials for making light shaping optics, allow for the use of thermally and mechanically robust high refractive index materials for creating environmentally durable (e.g., able to withstand high humidity and/or temperature) LSO products, eliminate interfacial stress as potential failure mechanism observed in certain PoG LSO products, and/or enable the integration of stacks of thin film optical elements (e.g., filters) into LSO devices.

Several types of polymers available as thin foils (e.g., films) offer an attractive alternative to both photo-polymers and inorganic materials for application in LSO products. These polymeric foils provide precise thickness control, high surface and optical quality, high refractive indices and exceptional environmental durability. These foils may be used as the optical layer in realizing a new architecture of variety of LSO devices to take advantage of the aforementioned attributes of the polymeric foils.

These thin foils of a high refractive index material can include, for example, Kapton^{®}, Ultem^{®}, or Extem^{TM}. These material are typically processed via injection molding or hot embossing, which may not be suitable for achieving micron-sized features. The refractive index of the high refractive index material can range from 1.63 to 1.7 at 850 nm. The high refractive index material may be used to provide an optical medium for realizing a target (e.g., predetermined, desired) light shaping function. The target light shaping function may include converting a collimated laser beam by expanding it into a specific finite shaped characterized by a distance and/or angle-dependent spatial light intensity distribution. To create this optical light shaping function, the surface of the polymeric foil may be textured with features of specific shapes, sizes and spatial distribution. Depending on the shapes, dimensions, and spatial distribution of those surface features created, this high refractive index foil may function as an optical surface diffuser, diffractive (e.g., diffraction) elements, micro-lens array, etc. or a combination thereof.

The advantages of these thin foils made of a high refractive index material can include (1) access to low cost, high optical quality, high refractive index polymeric materials, (2) use of optical polymeric materials that offer high thermal stability, chemical stability, and environmental stability, (3) enhanced product reliability due to reduced stress on the interface between rigid substrate and polymeric optically active layer, (4) simplified manufacturing of LSO devices by replacing a process involving mold-tool replication with alternative surface texturing approaches, (5) providing mechanical strength to products using thin and ultrathin rigid substrates, and/or (6) chemical inertness and/or stability of polymeric materials to provide for low outgassing and/or biocompatibility profiles of the LSO devices. Additionally, using available high refractive index foils can provide (1) improved control over the reliability of the light shaping optical elements and (2) improved durability and reliability performance compared to polymeric materials used in nanoparticle-loaded polymeric materials.

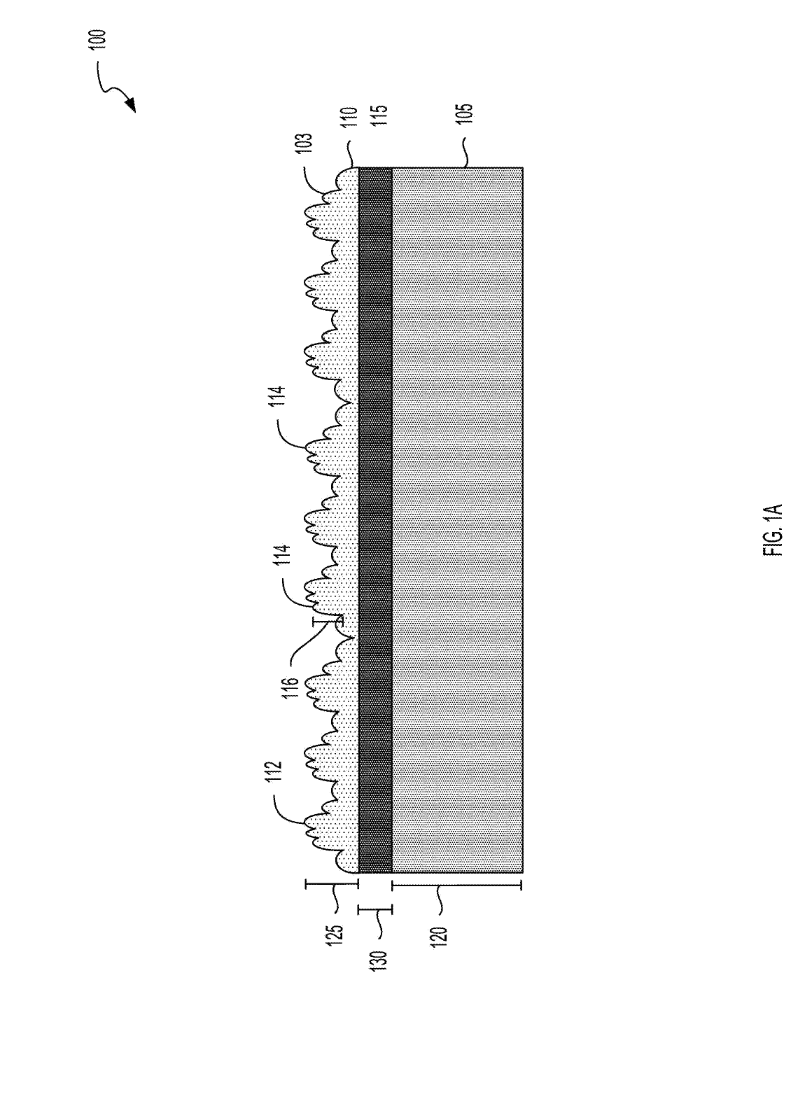

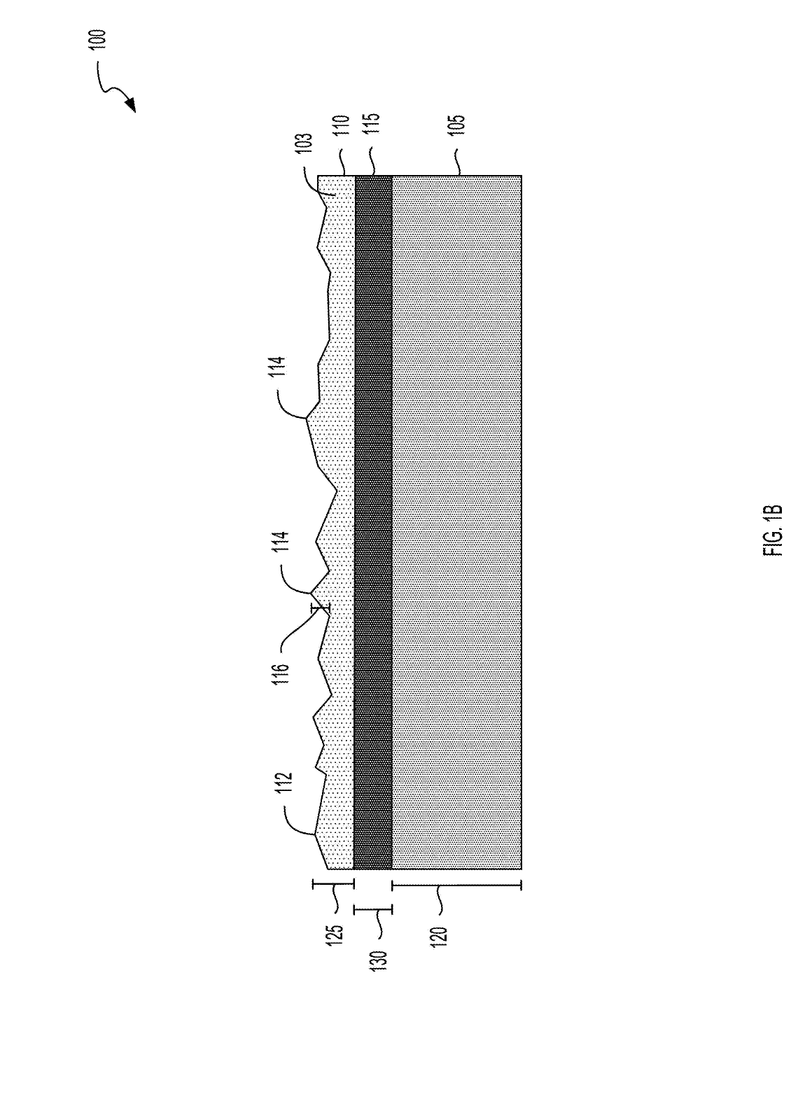

FIGS. 1A and 1B are cross-sectional views of an example optical device 100. The optical device 100 may be part of an electronic device, such as a phone or headset. For example, the optical device 100 can form a glass screen of the phone or headset.

The optical device 100 may include a light shaping optical element 103 (e.g., one or more light shaping optical elements). The light shaping optical element 103 may be disposed in at least one of a diffuser, a lens, a micro-lens array, or a polarization controller. The light shaping optical element 103 may include multiple layers of different material. For example, the light shaping optical element 103 may include various layers as described below. FIG. 1A depicts the light shaping optical element 103 exhibiting a periodicity of surface features and structures, which repeat over the length/area of the optical device 100. FIG. 1B depicts the light shaping optical element 103 exhibiting aperiodic (e.g., not periodic, irregular, random) surface features and structures.

The light shaping optical element 103 may include a substrate 105 (e.g., one or more substrates 105). The substrate 105 may be composed of (e.g., made of) glass (e.g., borosilicate glass, float glass). For example, the substrate 105 may include a flat piece of glass. The substrate 105 may be composed of fused silica, and/or another type of material. The substrate 105 can be composed of ceramics, semiconductors, polymeric materials, synthetic mineral materials, natural mineral materials, and or composite materials. In some examples, the substrate 105 is composed of silicon or sapphire. The substrate 105 may include a rigid (e.g., stiff) substrate. For example, a rigid substrate can include a substrate having a shear modulus greater than 15 GPa. The rigidity of the substrate 105 can provide mechanical robustness (e.g., stiffness) to the light shaping optical element 103. The substrate 105 can withstand elastic deformation under a load.

The substrate 105 may have a thickness 120. The thickness 120 of the substrate 105 may be greater than 0.1 mm. The thickness 120 of the substrate 105 can affect the rigidity of the substrate 105. For example, a thicker substrate can have a higher rigidity than a thinner substrate. While the thickness 120 of the substrate 105 may be related to the rigidity of the substrate 105, a thinner substrate made of a certain material may have a higher rigidity than a thicker substrate made of a different material.

The light shaping optical element 103 may include one or more films 110 (e.g., foils, film layer, light shaping optical layer). The film 110 may be disposed (e.g., positioned) on the substrate 105. The film 110 may be chemically bonded to the substrate 105. Chemically bonding the film 110 to the substrate 105 may eliminate or reduce stress from the interface between the film 110 and the substrate 105, increase environmental durability and reliability of the final product, and/or increase mechanical durability of the substrate 105.

The film 110 may include a polymer (e.g., polymeric foil). For example, the film 110 may be made of the polymer. The polymer may include a polyimide. The polymer may have a melting point greater than 400°C. The polymer may show no discernable melting below 400°C. The polymer may have a glass transition temperature greater than 200°C.

The polymer may have a refractive index greater than 1.5. For example, the polymer may have a refractive index of greater than 1.5 at 850 nm. The refractive index of the polymer may be greater than 1.5 without scattering light. The film 110 may have a refractive index greater than 1.5. For example, the film 110 may have a refractive index of greater than 1.5 at 850 nm. The refractive index of the film 110 may be greater than 1.5 without scattering light. The refractive index of the film 110 can be achieved without using a nanoparticle dispersion in the film 110.

The film 110 may include a single-phase material that includes the polymer. For example, the film 110 may be made entirely of the polymer. The film 110 may be made of one or more polymers. The film 110 may be free of nanoparticles. For example, the film 110 may be free of oxide nanoparticles.

In contrast to devices formed by methods that involve curing a liquid polymer, the light shaping optical element 103 of the present disclosure may be free of interfacial stresses. While the light shaping optical element 103 may have inherent stresses at the surface, this inherent stress can be much smaller compared to the stresses that are created by the liquid polymer method, which can include the stresses that are built up the liquid polymer method. The stress created by the liquid polymer method can be due to (1) curing the liquid polymer on the substrate using a UV curing process and (2) the change in volume of the liquid polymer as the polymer solidifies on the substrate. The light shaping optical element 103 can be free of the stresses created by the liquid polymer method by avoiding these processing steps. Instead, the light shaping optical element 103 can be formed by a chemical bonding process using an optical epoxy. The individual dies of the light shaping optical elements 103 can be formed without introducing stress into the entire optical device 100 or the wafer. The stress at the interface between the film 110 and substrate may not be affected by the internal stresses of the film and the substrate. The stress at the interface between the substrate 105 and the film 110 may be reduced or eliminated.

The film 110 may have a thickness 125. The thickness 120 of the film 110 may be defined by a distance between the highest point of the film 110 and the lowest point of the film 110. The thickness 120 of the film 110 may be greater than 15 µm. The thickness 120 of the film 110 may be less than the thickness 120 of the substrate 105. The thickness 120 of the film 110 may be related to the refractive index of the film 110. For example, to achieve equivalent optical properties (e.g., transmission, reflection), a film with a higher refractive index can be thinner than a film with a lower refractive index.

The film 110 may include a surface 112. The surface 112 of the film 110 may include a plurality of features 114. The plurality of features 114 may be configured to interact with light. For example, the plurality of features 114 may impact the trajectory of light interacting with the film 110. The plurality of features 114 may control the transmission of the light through the film 110. plurality of features 114 may control reflection of the light from the film 110. The plurality of features 114 may control the shape and/or intensity of light through or away from the film 110. The plurality of features 114 may include a plurality of grooves, dips,, ridges, circular and semicircular domes, lines or related structures with specific geometries to control the light. The surface features may form complex shapes repeating with desired (e.g., target) periodicity over the length and width of the surface 112 of the film. The complex shapes can include fundamental repeating features. As shown in FIG. 1A, the plurality of features 114 may be arranged periodically. For example, the plurality of features 114 may be arranged in a repeating manner. The periodicity can come from repeating smaller patterns to populate a larger area. Alternatively or in addition, the periodicity can be related to the function (e.g., light shaping function, optical function) of the light shaping element 103. For example, certain elements can be positioned with a periodic spatial distribution. As shown in FIG. 1B, the plurality of features 114 may be arranged randomly, or not periodically.

Each of the plurality of features 114 may have an in-plane dimension 116. The in-plane dimension 116 may be less than the thickness 125 of the film 110. For example, if the thickness of the film 110 is 15 µm, then the in-plane dimension 116 of each of the plurality of features 114 may be less than 15 µm. If the thickness of the film 110 is 20 µm, then the in-plane dimension 116 of each of the plurality of features 114 may be less than 20 µm. If the thickness of the film 110 is 50 µm, then the in-plane dimension 116 of each of the plurality of features 114 may be less than 50 µm. In some embodiments, the in-plane dimension 116 may be equal to the thickness 125 of the film 110.

The in-plane dimension 116 of each of the plurality of features 114 may be defined by a height of each of the plurality of features 114. The in-plane dimension 116 of each of the plurality of features 114 may be defined by a depth of each of the plurality of features 114. The in-plane dimension 116 of each of the plurality of features 114 may be defined by a distance between the highest point of the feature and the lowest point of the feature. The plurality of features 114 may provide a texture to the surface 112.

The light shaping optical element 103 may include a bonding layer 115 (e.g., one or more bonding layers). The bonding layer 115 may include a chemical bonding layer. The film 110 may be chemically bonded to the substrate 105 by the bonding layer 115. The bonding layer 115 may include an adhesive (e.g., chemical adhesive, epoxy). The film 110 may be disposed on a side of the bonding layer 115 opposite the substrate 105.

The bonding layer 115 may have a thickness 130. The thickness 130 of the bonding layer 115 may be in a range of 0.1 µm and 20 µm. The thickness 130 of the bonding layer 115 may be less than the thickness 125 of the film 110. In some examples, the thickness 130 of the bonding layer 115 is greater than or equal to the thickness 125 of the film 110. The thickness 130 of the bonding layer 115 may be less than the thickness 120 of the substrate 105.

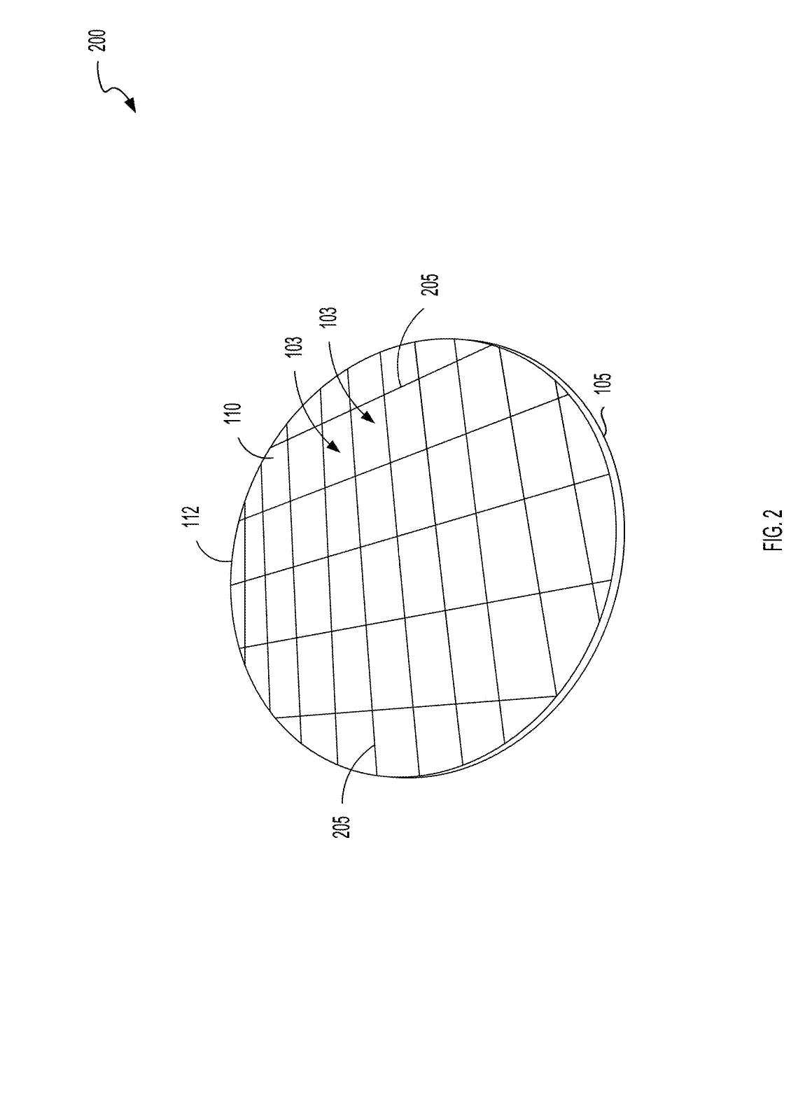

FIG. 2 is a perspective view of an example wafer structure 200. The wafer structure 200 may include the substrate 105 and the film 110 described above. The film 110 may be chemically bonded to the substrate by the chemical bonding layer 115 described above. The wafer structure 200 may be made of a plurality of light shaping optical elements 103 described above. The wafer structure 200 may be diced along saw-lines 205 (e.g., dicing lines) to obtain the plurality of light shaping optical elements 103. In some embodiments, the wafer substrate has a thickness of greater than 0.1 mm, the film 110 has a thickness of greater than 15 µm, and the chemical bonding layer has a thickness in a range of 0.1 µm and 20 µm. The diameter of the wafer structure 200 can be less than or equal to 300 mm. In some examples, the diameter of the wafer structure 200 can be greater than 300 mm.

The film 110 may include a polymer having a refractive index greater than 1.5. The surface 112 of the film 110 may include the plurality of features 114 described above. The plurality of features 114 may be configured to interact with light. In some embodiments, each of the plurality of features 114 has an in-plane dimension less than the thickness of the film 110. In some embodiments, the substrate 105 has a thickness of greater than 0.1 mm, the film 110 has a thickness of greater than 15 µm, and the chemical bonding layer has a thickness in a range of 0.1 µm and 20 µm. In some embodiments, the film 110 is free of oxide nanoparticles. In some embodiments, the film 110 includes a single-phase material that includes the polymer.

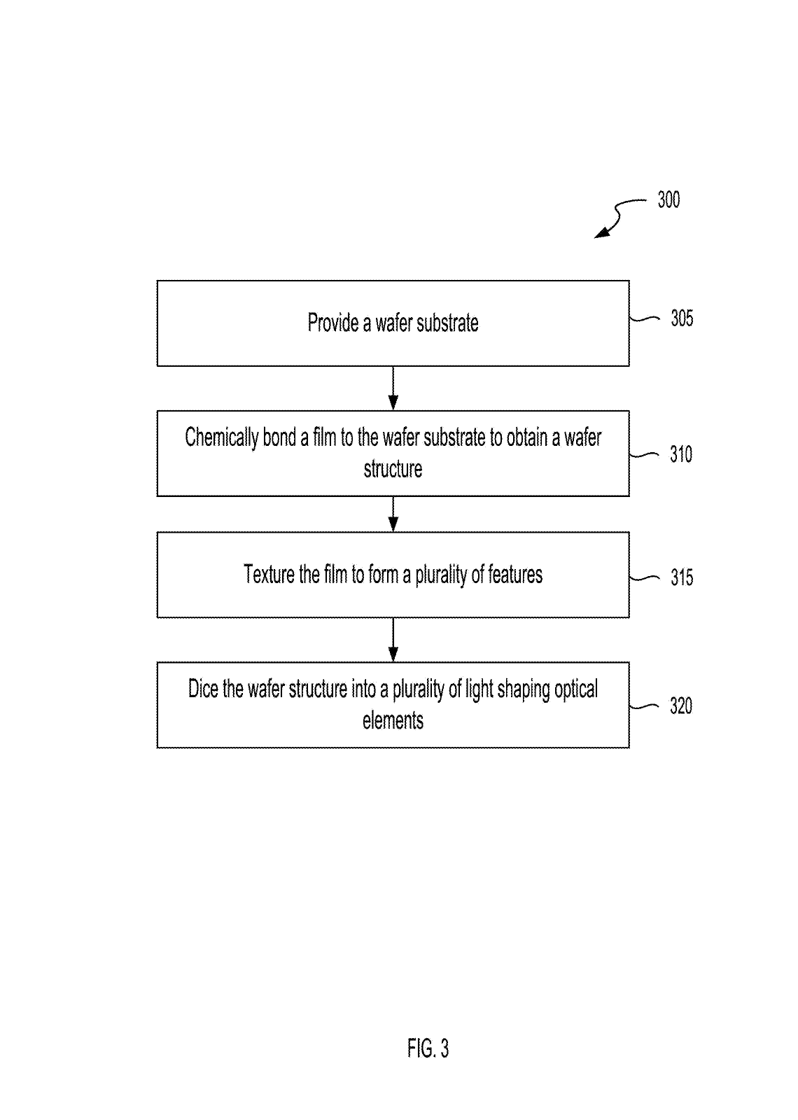

FIG. 3 is a flowchart of an example process associated with manufacturing a light shaping optical device (e.g., optical device 100). The process 300 may include chemically bonding a polymeric foil to a rigid substrate (e.g., a substrate having a shear modulus greater than 15 GPa). The process of making the light shaping optical element of the present disclosure can include (1) chemically bonding the thin polymeric foil to a wafer of rigid optical material, (2) texturing the thin polymeric foil bonded to the rigid substrate wafer with a pattern of surface features or elements, and (3) dicing the bonded foil/wafer into single device dies. The steps of process 300 may be performed by various semiconductor manufacturing equipment. The process 300 can result in dies that are uniform across a plurality of dies. The repeatability and fidelity of the process 300 can increase the manufacturing yield of high-quality dies.

At step 305, process 300 may include providing a wafer substrate. The wafer substrate may include the substrate 105. The selection of the material for the wafer substrate may depend on the functional requirements of the final device. For example, the selection of the material for the wafer substrate may be driven by parameters such as (1) expected spectral range of operation of the optical device 100, (2) manufacturing process conditions, (3) expected method of integration and packaging in a module, and/or (4) exposure to environmental factors.

At step 310, process 300 may include chemically bonding the film 110 to the wafer substrate. For example, the process 300 may include chemically bonding the film 110 to the wafer substrate to obtain the wafer structure 200. The film 110 may include a polymer having a refractive index greater than 1.5. Chemically bonding the film 110 to the wafer substrate may occur after to providing the wafer substrate.

At step 315, process 300 may include texturing the film 110. For example, process can include texturing the film 110 to form the plurality of features 114. The plurality of features 114 can interact with light. Texturing the film 110 can include introducing a pattern to the film 110. The film 110 can be textured with a stamp. Texturing the film 110 can include ion etching the film. The film 110 can be textured after the film 110 is chemically bonded to the wafer substrate. Alternatively, the film 110 can be textured before the film 110 is chemically bonded to the wafer substrate.

At step 320, process 300 may include dicing the wafer structure 200 into the plurality of light shaping optical elements 103. The plurality of light shaping optical elements 103 may include one or more light shaping optical elements having the plurality of features 114 configured to interact with light. Each of the plurality of features 114 may have an in-plane dimension less than a thickness of the film 110. The wafer structure 200 may be diced into the plurality of light shaping optical elements 103 after the film 110 is textured.

In some embodiments, texturing the film includes introducing, by lithography, a pattern onto the film 110. The lithography may include electron beam lithography (e-beam lithography), direct laser lithography, direct laser writing, nanoimprint lithography, a stamp-like replication process, laser beam lithography, resistant photomask lithography, or any other lithographic technique. Lithography can be used to form the pattern on the film 110. The pattern can be introduced onto the film 110 after chemically bonding the film 110 to the wafer substrate. Alternatively, in some embodiments, pattern can be introduced onto the film 110 before chemically bonding the film 110 to the wafer substrate. The pattern can be introduced onto the film 110 before dicing the wafer structure 200 into the plurality of light shaping optical elements 103.

In some embodiments, a photoresist can be deposited onto the wafer structure 200. The photoresist can be textured with a stamp. The photoresist may have a pattern. The photoresist may be disposed on the film 110. Disposing the photoresist onto the wafer structure 200 may occur subsequent to chemically bonding the film 110 to the wafer substrate. One or more portions of the photoresist may be removed. Removing the one or more portions of the photoresist may include ion etching the photoresist. The one or more portions of the photoresist may be removed subsequent to disposing the photoresist onto the wafer structure 200. The one or more portions of the photoresist may be removed subsequent to chemically bonding the film 110 to the wafer substrate. Removing the one or more portions of the photoresist may include creating a texture in the photoresist.

The semiconductor manufacturing equipment may include one or more computing devices, chemical bonding systems, photoresist applicators, ion etching tools, wafer dicing machinery, electron beam lithography tools, and/or one or more other components. The one or more computing devices may include a bus, one or more processors, memory (e.g., one or more memories), one or more storage components, an input component, an output component, and/or a communication interface.

In some implementations, the one or more processors may be configured or programmed to cause the semiconductor manufacturing equipment to perform one or more processes described herein, including process 300. The memory includes a random access memory (RAM), a read only memory (ROM), and/or another type of dynamic or static storage device (e.g., a flash memory, a magnetic memory, and/or an optical memory) that stores information and/or instructions for use by the one or more processors. The communication interface may permit semiconductor manufacturing equipment to receive information from another device and/or provide information to another device.

The semiconductor manufacturing equipment may perform these processes based on the one or more processors executing software instructions stored by one or more non-transitory computer-readable media, such as the memory. The one or more non-transitory computer-readable media is defined herein as one or more non-transitory memory devices that include memory space within a single physical storage device or memory space spread across multiple physical storage devices. Software instructions may be read into the memory and/or the storage component from one or more computer-readable media or from another device via a communication interface. When executed, software instructions stored in memory and/or storage component may cause the or more processors to perform one or more processes described herein. Additionally, or alternatively, hardware circuitry may be used in place of or in combination with software instructions to perform one or more processes described herein. Thus, implementations described herein are not limited to any specific combination of hardware circuitry and software.

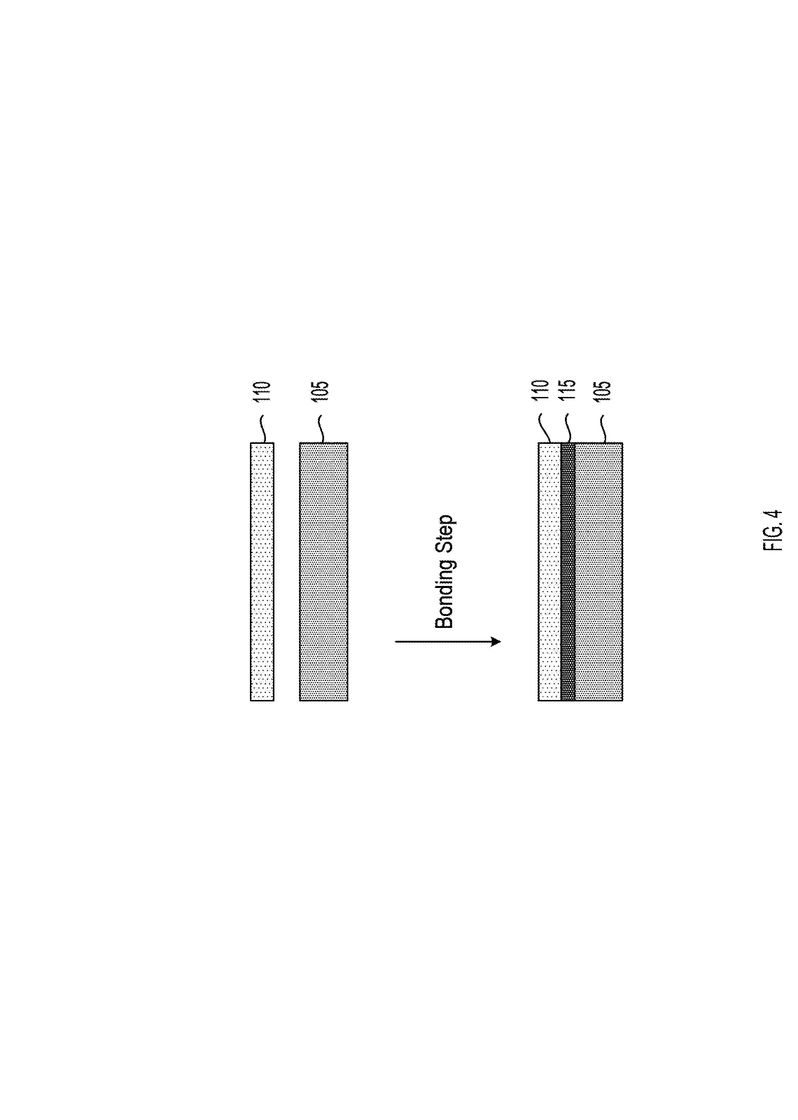

FIG. 4 illustrates a chemical bonding step (e.g., step 310) of the example process associated with manufacturing the light shaping optical device. The film 110 may be chemically bonded to the substrate 105. The chemical bonding step may include bonding the film 110 to the substrate 105. The film 110 may be pristine such that the film 110 is smooth and/or does not include the plurality of features 114 shown in FIG. 1. Alternative, the film 110 may be surface-textured such that the film 110 includes the plurality of features 114. The selection of the type of bonding technique may depend on the functional requirements for the final devices. For example, the selection of the chemical bonding technique may be driven by parameters such as (1) expected spectral range of operation of the optical device 100, (2) manufacturing process conditions, (3) expected method of integration and packaging in a module, and/or (4) exposure to environmental factors. The specific technique of chemical bonding may include the use of optical adhesives, heat-fusion with the substrate 105, and/or optical bonding of chemically treated surfaces of the film 110 and the substrate 105. Depending on the specific light shaping function of the optical device 100, the thickness 125 of the film 110 may range from 5 µm to up to 50 µm and beyond.

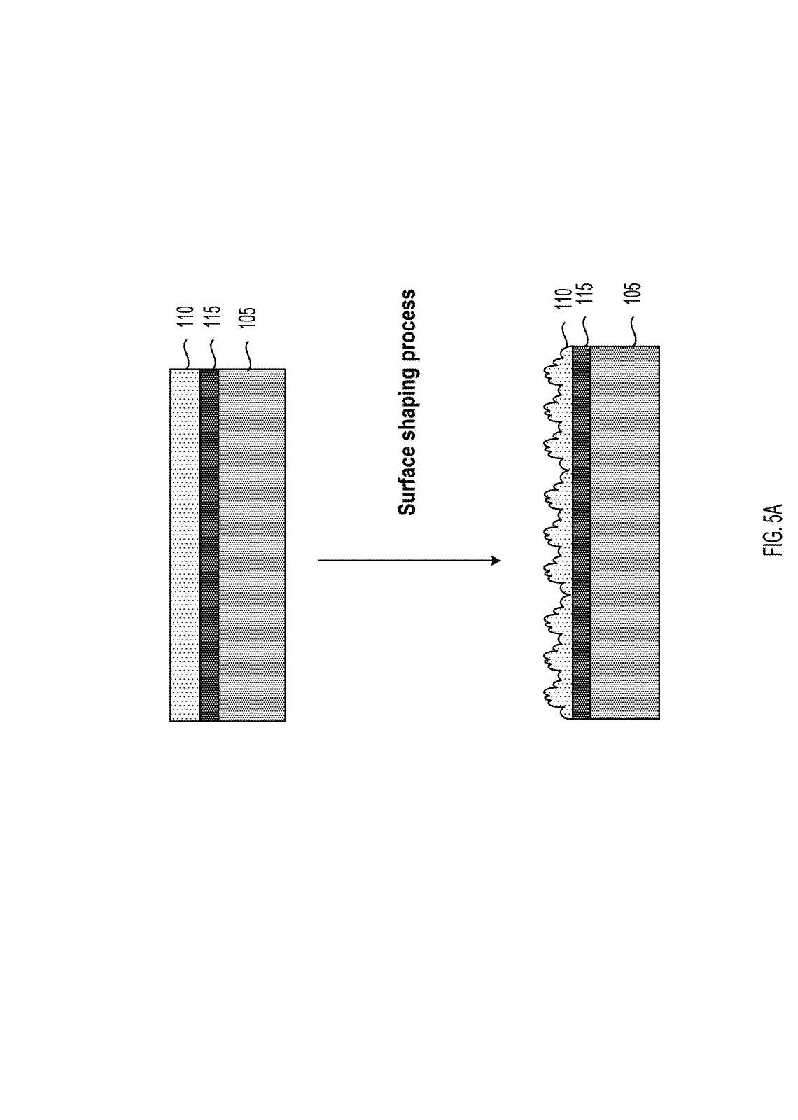

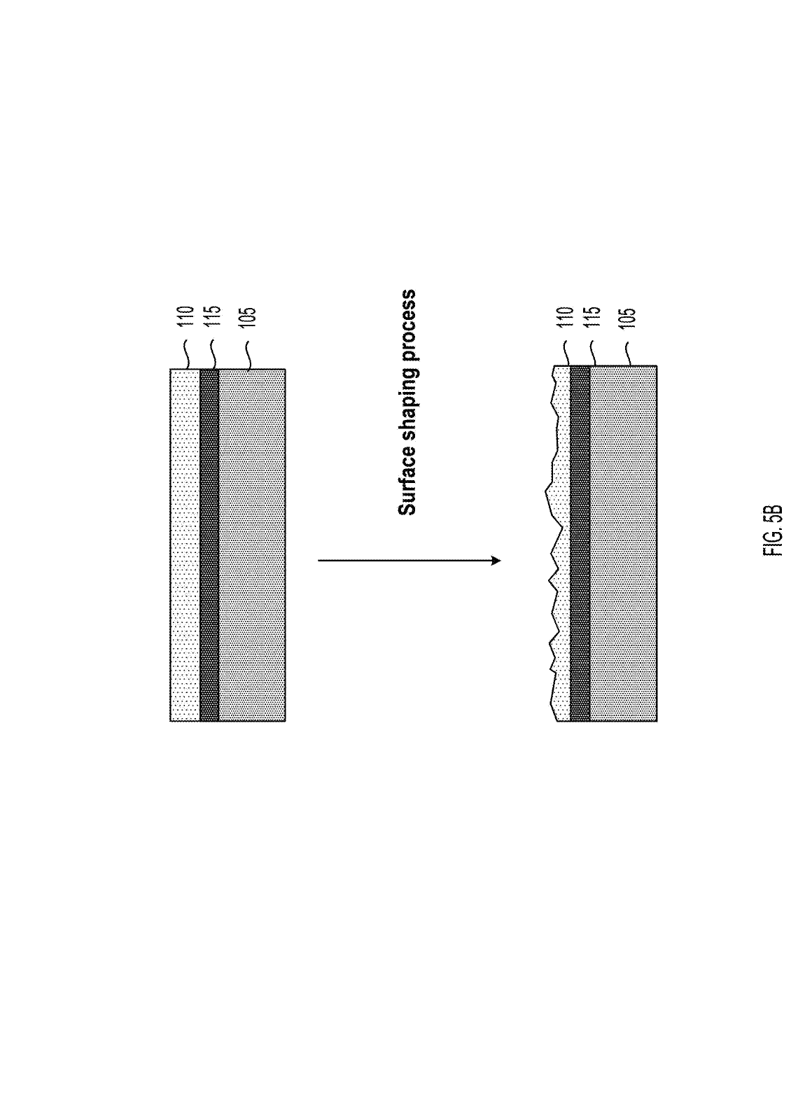

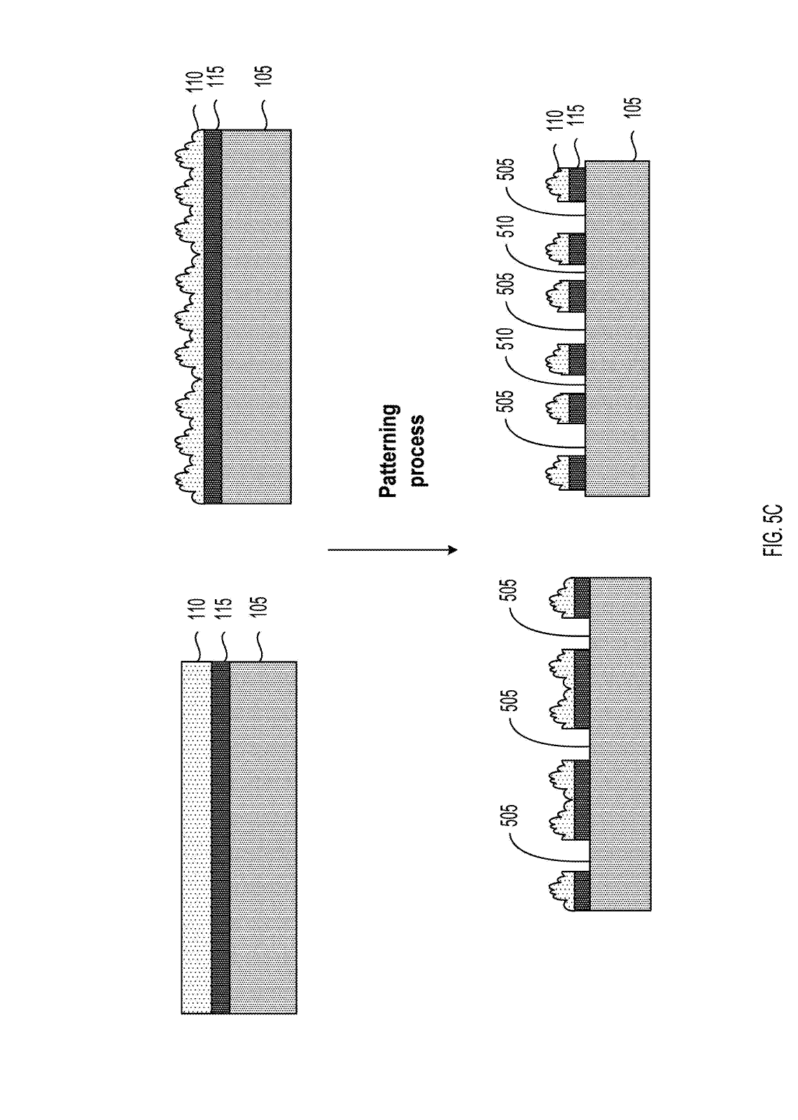

FIGS. 5A, 5B, and 5C illustrate a texturing step (e.g., step 315) of the example process associated with manufacturing the light shaping optical device. The texturing step can include texturing the film 110. During this step, the surface of the film 110 may be shaped to create the structure of surface features. These features (e.g., plurality of features 114) may come in different shapes and/or sizes. The shapes and sizes of the features can be determined by the target light shaping function of the optical device 100. The spatial distribution of these features can also vary and depend on target light shaping function of the optical device 100. The light shaping function can change the properties of light being transformed by the optical device 100. As shown in FIG. 5A, the surface of the film 110 may be shaped to have a periodic, repeating form over the surface of the film 110. As shown in FIG. 5B, the surface of the film 110 may be shaped to have a random, irregular form over the surface of the film 110.

As shown in FIG. 5C, the texturing step may include a patterning process in which portions of the film 110 and the bonding layer 115 are removed from windows 505 and/or dicing lanes 510. For example, portions of the film 110 and the bonding layer 115 may be removed to produce the windows 505 of any number, size, and/or shape. The patterning process may be part of the surface shaping process, or it may be a separate step from the surface shaping process. For example, the patterning process in which portions of the film 110 and the bonding layer 115 are removed can be part of the process by which the surface of the film 110 is shaped. In another example, the patterning process in which portions of the film 110 and the bonding layer 115 are removed can be a separate step from the process by which the surface of the film 110 is shaped. The lower left portion of FIG. 5C shows the windows 505 free of the film 110 and the bonding layer 115. The lower right portion of FIG. 5C shows the windows 505 and the dicing lanes 510 free of the film 110 and the bonding layer 115. The periodicity of the dicing lanes 510 can coincide with the periodicity of the surface features and structures.

The techniques used for the shaping the surface of the film 110 may include a replication process based on reactive ion etching or chemical etching. In some embodiments, the film 110 may be textured prior to chemically bonding the film 110 to the substrate 105. The film 110 may have the target texturing features of the surface introduced directly during the foil extrusion process. In such a case, the film 110 carrying the textured surface may be chemically bonded to the substrate 105 and the shaping process step shown in FIGS. 5A, 5B, and 5C would be eliminated.

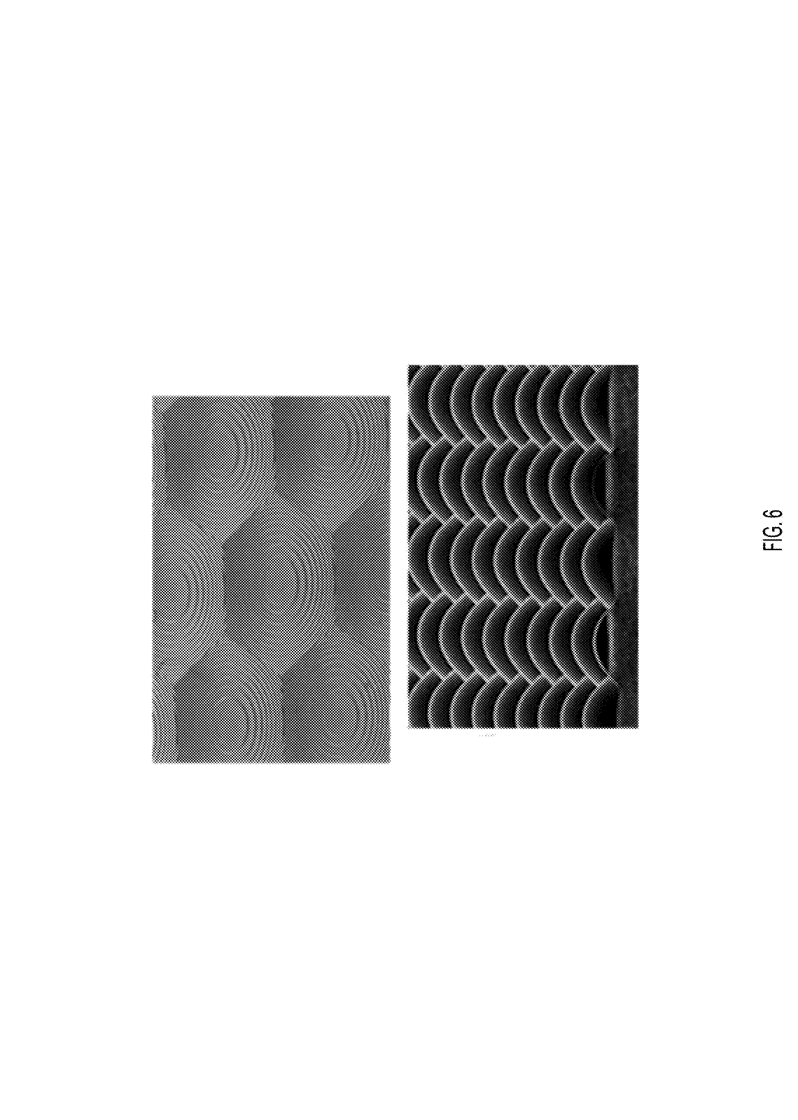

FIG. 6 shows example scanning electron microscopy images of surface texture. The surface texture may include the plurality of features 114. The plurality of features 114 may be disposed on the film 110. The plurality of features 114 may be part of the film 110. The SEM images illustrate examples of different surface texturing that can be achieved by the surface shaping step described with respect to FIGS. 5A, 5B, and 5C. The plurality of features 114 may include protrusions. For example, the plurality of features 114 may include rows of protrusions. The plurality of features 114 may include depressions. For example, the plurality of features 114 may include rows of depressions. The plurality of features 114 can include concentric rings and/or hexagonal patterning.

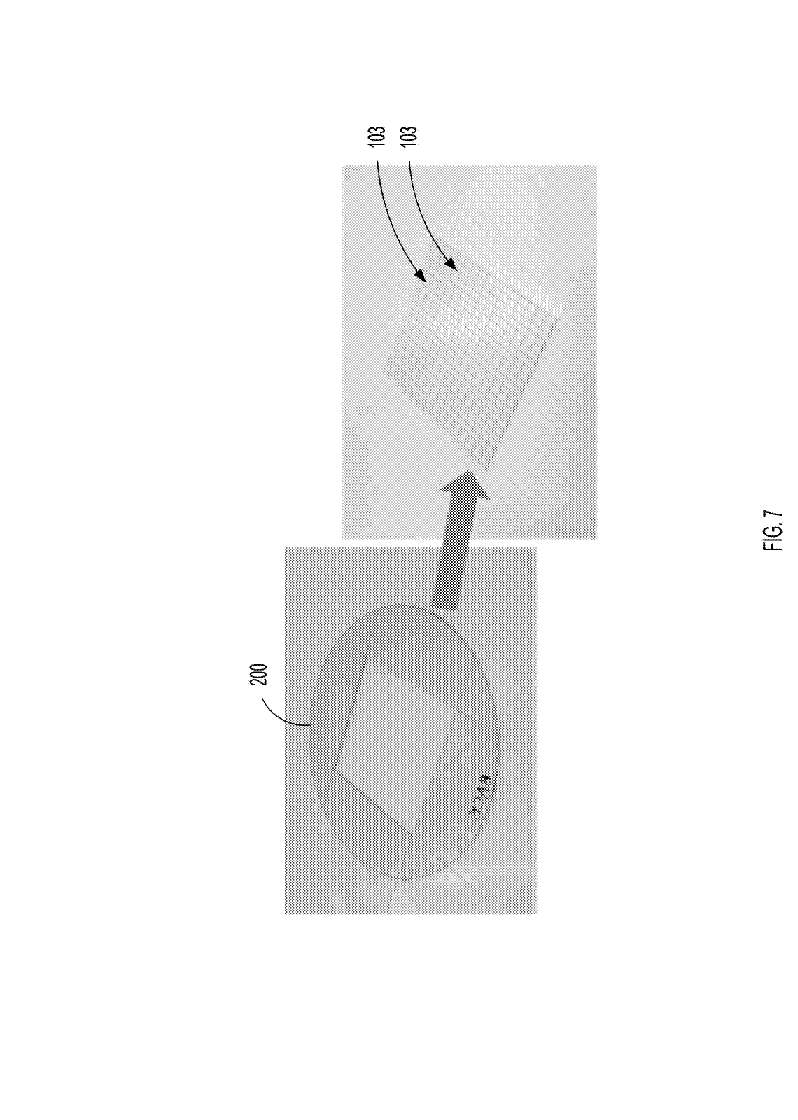

FIG. 7 illustrates a dicing step (e.g., step 320) of the example process associated with manufacturing the light shaping optical device. The wafer structure 200 may be diced into individual light shaping optical elements 103 (e.g., dies). The dicing step can include forming individual dies. As shown, the dies are 2 mm x 3 mm. However, any sized dies may be formed in the dicing step. In this example, the wafer structure 200 was 100 mm in diameter and a 50 µm thick foil of Extem^{TM} XH1015 was polymer bonded to 1.1 mm thick Schott D263 T^{®} glass using an optical adhesive.

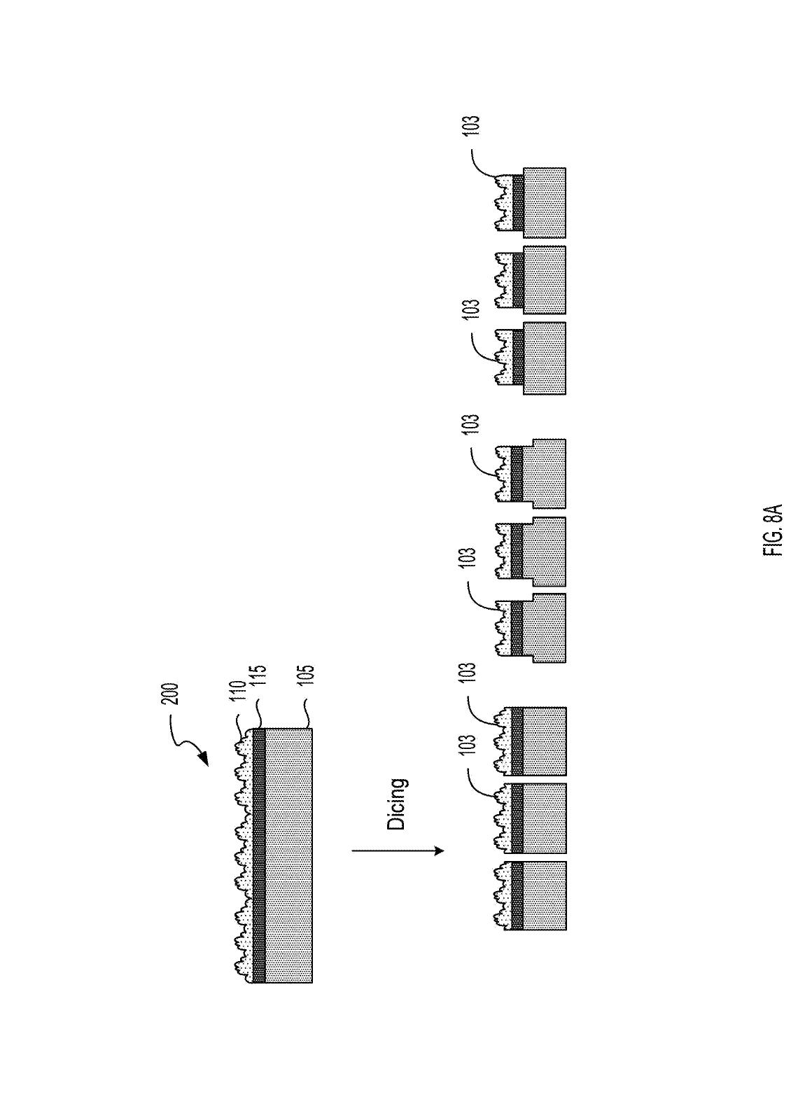

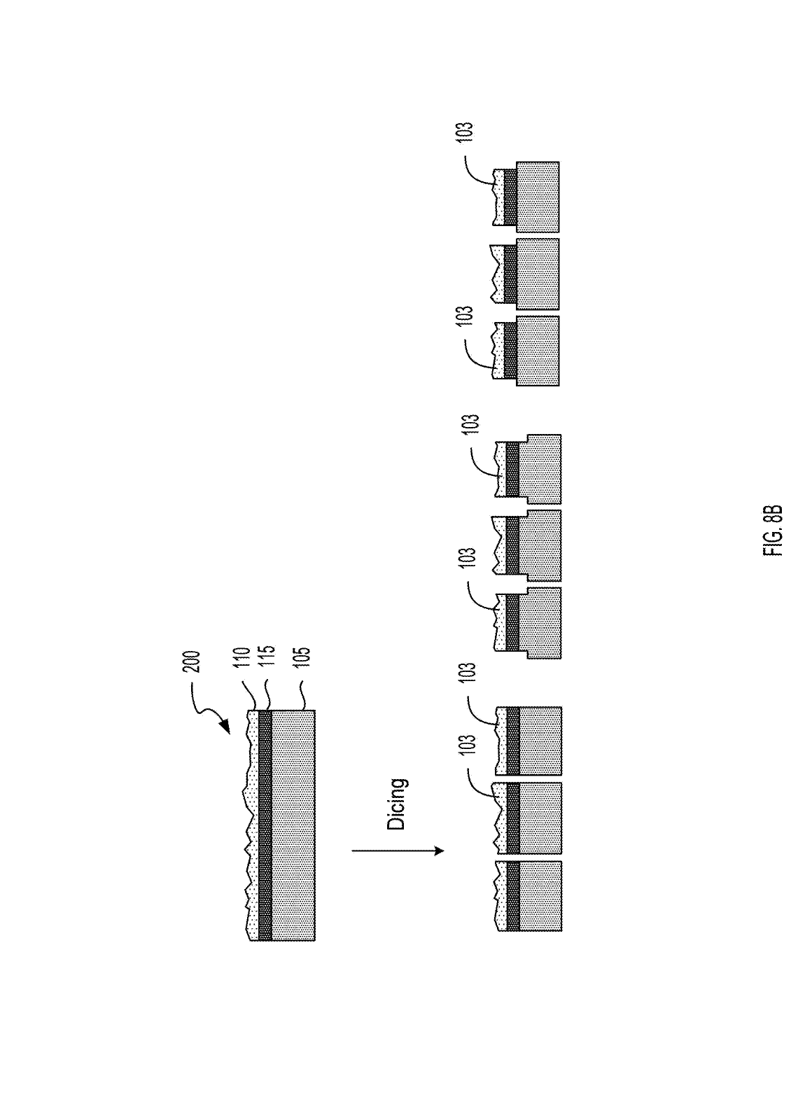

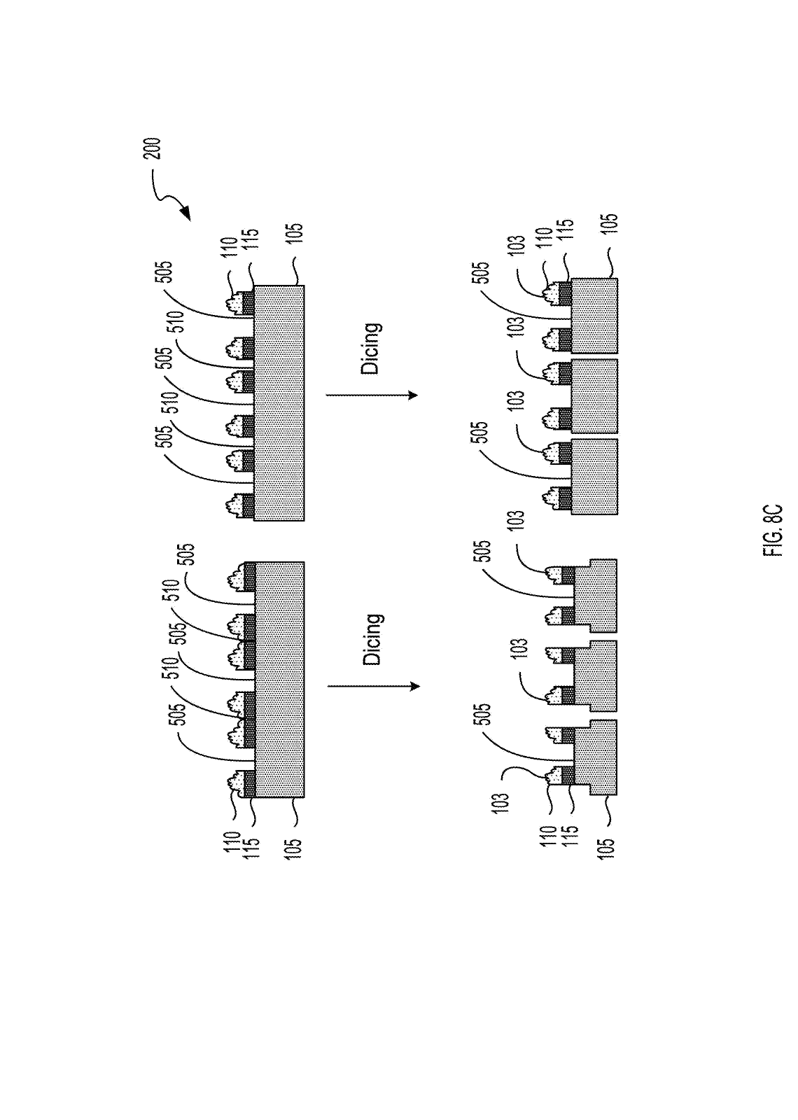

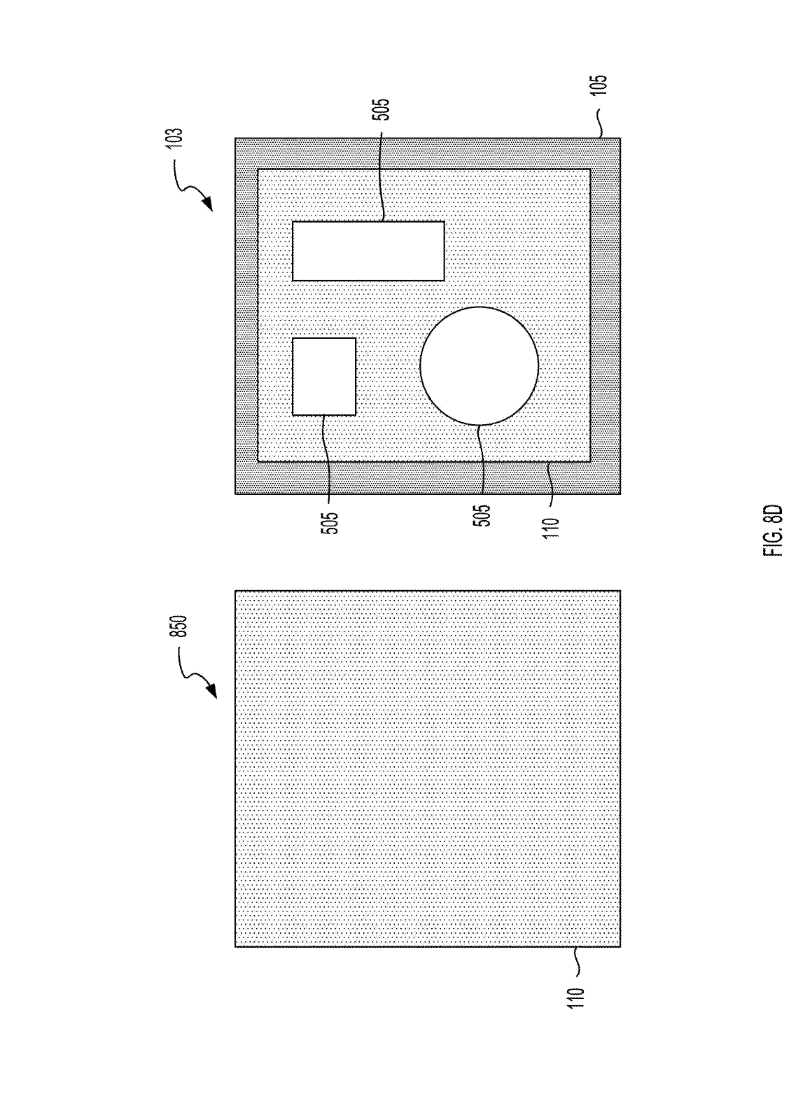

FIGS. 8A, 8B, and 8C illustrate a dicing step (e.g., step 320) of the example process associated with manufacturing the light shaping optical device. The wafer structure 200 includes the substrate 105, the film 110, and the bonding layer 115. Various profiles of the light shaping optical element 103 are shown after the wafer structure 200 is diced. Various profiles of the saw-lines that can be applied in the step of dicing the wafer structure are shown. For example, the light shaping optical element 103 may include straight-cut edges whereby the edges of the substrate 105, the film 110, and the bonding layer 115 are aligned, as shown in the lower left portion of FIGS. 8A and 8B. The light shaping optical element 103 may include stepped edges whereby the edges of the film 110, the bonding layer 115, and a portion of the substrate 105 are aligned, as shown in the lower middle portion of FIGS. 8A and 8B. Portions of the edges of the substrate 105 protrude outward from the edges of the film 110, the bonding layer 115, and the portion of the substrate 105 aligned with the film 110 and bonding layer 115. The light shaping optical element 103 may include stepped edges whereby the edges of the film 110 and the bonding layer 115 are aligned, as shown in the lower right portion of FIGS. 8A and 8B. The edges of the substrate 105 protrude outward from the edges of the film 110 and the bonding layer 115. As shown in FIG. 8A, the surface of the film 110 may have a periodic, repeating form over the surface of the film 110. As shown in FIG. 8B, the surface of the film 110 may have a random, irregular form over the surface of the film 110. FIGS. 8A and 8B show the dicing process for a non-patterned wafer structure 200. For example, the wafer structure 200 shown in FIGS. 8A and 8B may be free of windows and/or dicing lanes.

FIG. 8C illustrates the dicing step for a patterned wafer structure 200. For example, the patterned wafer structure 200 may include the windows 505 and/or the dicing lanes 510. The light shaping optical element 103 may include stepped edges whereby the edges of the film 110, the bonding layer 115, and a portion of the substrate 105 are aligned, as shown in the lower left portion of FIG. 8C. The height of the substrate 105 at the window 505 can be higher than the height of the substrate 105 at the dicing lane 510. The light shaping optical element 103 may include stepped edges whereby the edges of the film 110 and the bonding layer 115 are aligned, as shown in the lower right portion of FIG. 8C. The height of the substrate 105 at the window 505 can be the same as the height of the substrate 105 at the dicing lane 510.

FIG. 8D illustrates top views of an unpatterned die 850 and a patterned die (e.g., light shaping optical element 103). The unpatterned die 850 shown on the left can be patterned to form the light shaping optical element 103 shown on the right. The light shaping optical element 103 can include the windows 505. The window 505 can include portions of the light shaping optical element 103 where the film 110 and the bonding layer 115 are removed to reveal the substrate 105. The windows 505 can allow the light shaping optical element 103 to accommodate or combine with optical features such as optical filters for controlling the wavelength and amplitude of light. The windows 505 can be formed by a variety of lithographic and non-lithographic patterning processes. Removal of the film 110 and the bonding layer 115 at the edge of the light shaping optical element 103 (e.g., around the border of the light shaping optical element 103) can be achieved by a patterning process of a 2-step (dual-blade) dicing process.

### EXPERIMENTAL DATA

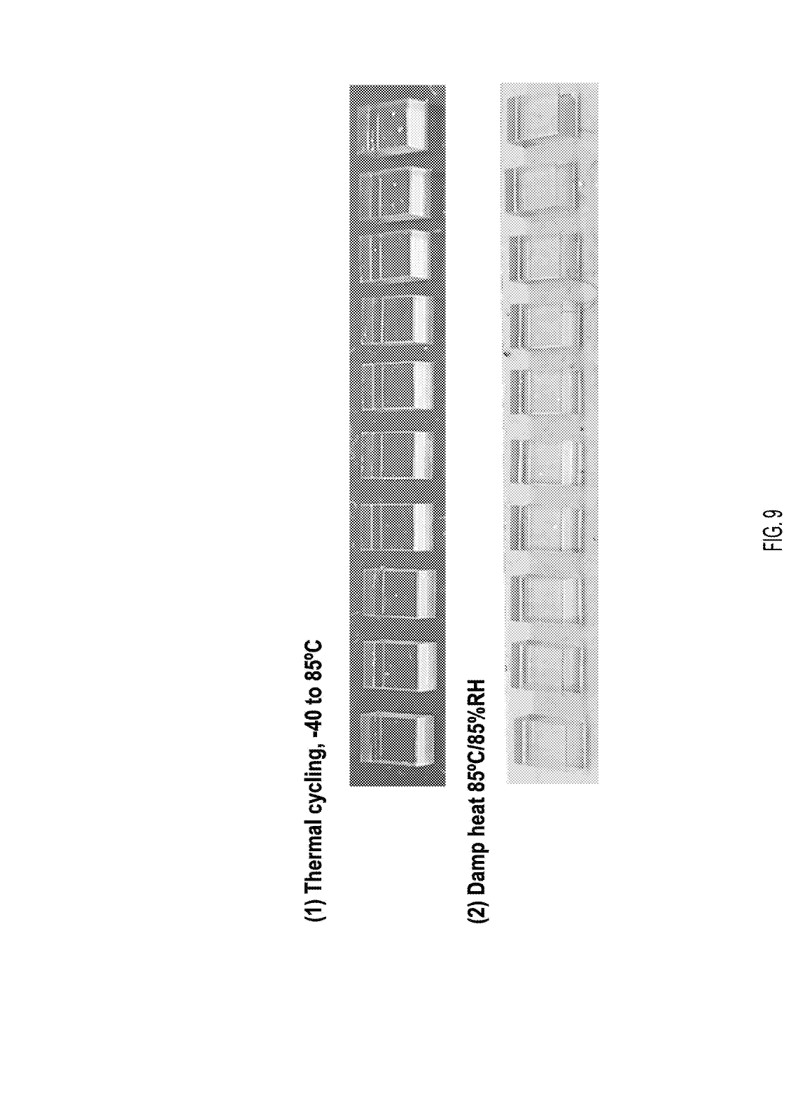

FIG. 9 illustrates results from high temperature and high humidity reliability tests of dies formed by the process associated with manufacturing the light shaping optical device. The dies include the film 110 (Extem^{TM} XH1015 with a thickness of 0.002 inches) laminated to the substrate 105 (D263 T^{®} eco with dimensions of Ø 100 mm x 1.1 mm) by the chemical bonding layer 115 (EPO-TEK^{®} 301-2). In the experiments, the 2 mm x 3 mm dies were tested by a test protocol that included (1) 1005 cycles of thermal cycling of -40°C to 85°C, with 5 minutes temperature ramp and 30 minutes soak time (e.g., dwells) and (2) 1009 hrs. of continuous exposure to 85% relative humidity (RH) at 85°C. The results of the reliability tests are shown. All the dies passed both high humidity/temperature and temperature cycling tests without showing any signs of delamination, diced edges, or detrimental effects.

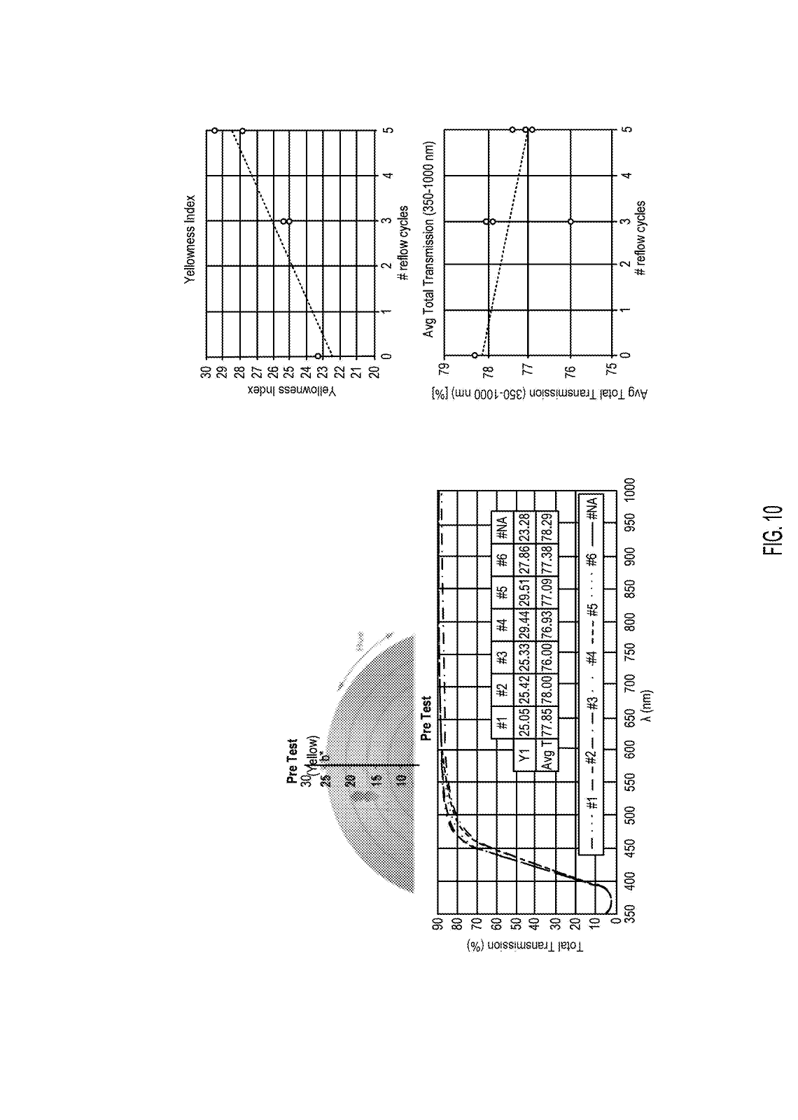

FIG. 10 illustrates results from a solder reflow test of dies formed by the process associated with manufacturing the light shaping optical device. The dies include the film 110 (Extem^{TM} XH1015 with a thickness of 0.002 inches) laminated to the substrate 105 (D263 T^{®} eco) by the chemical bonding layer 115 (EPO-TEK^{®} 301-2). In this experiment, a separate set of 10×10 mm dies was prepared and subjected to a solder reflow test that included 5 cycles of bringing the samples up to 260°C to 265°C and holding them at this temperature for 30 seconds. In the solder reflow tests, the samples experienced slight yellowing with increasing number of cycles. Since these spectral changes occur at a certain wavelength range (e.g., short wavelengths), they may have an impact on the functional performance of the LSO element in the final device.

The following provides an overview of some Aspects of the present disclosure:

Aspect 1. An optical device, comprising: a light shaping optical element, comprising: a substrate having a shear modulus greater than 15 GPa; and a film chemically bonded to the substrate by a chemical bonding layer having a thickness in a range of 0.1 µm and 20 µm, the film comprising a polymer having a refractive index greater than 1.5, a surface, of the film, comprising a plurality of features configured to interact with light, and the film having a thickness of greater than 15 µm.

Aspect 2. The optical device of aspect 1, wherein each of the plurality of features has an in-plane dimension less than the thickness of the film.

Aspect 3. The optical device of any of aspects 1-2, wherein the film comprises a single-phase material that includes the polymer.

Aspect 4. The optical device of any of aspects 1-3, wherein the light shaping optical element is disposed in at least one of a diffuser, a lens, a micro-lens array, or a polarization controller.

Aspect 5. The optical device of any of aspects 1-4, wherein the film is free of oxide nanoparticles.

Aspect 6. The optical device of any of aspects 1-5, wherein the polymer comprises a polyimide.

Aspect 7. The optical device of any of aspects 1-6, wherein the refractive index of the polymer is greater than 2.

Aspect 8. The optical device of any of aspects 1-7, wherein the substrate has a thickness of greater than 0.1 mm.

Aspect 9. The optical device of any of aspects 1-8, wherein the polymer has a melting point greater than 400°C.

Aspect 10. The optical device of any of aspects 1-9, wherein the polymer has a glass transition temperature greater than 200°C.

Aspect 11. A wafer structure, comprising: a substrate; and a film chemically bonded to the substrate by a chemical bonding layer, the film comprising a polymer having a refractive index greater than 1.5, and a surface of the film comprising a plurality of features configured to interact with light.

Aspect 12. The wafer structure of aspect 11, wherein each of the plurality of features has an in-plane dimension less than a thickness of the film.

Aspect 13. The wafer structure of any of aspects 11-12, wherein: the substrate has a thickness of greater than 0.1 mm; the film has a thickness of greater than 15 µm; and the chemical bonding layer has a thickness in a range of 0.1 µm and 20 µm.

Aspect 14. The wafer structure of any of aspects 11-13, wherein the film is free of oxide nanoparticles.

Aspect 15. The wafer structure of any of aspects 11-14, wherein the film comprises a single-phase material that includes the polymer.

Aspect 16. A method, comprising: providing a wafer substrate; chemically bonding a film to the wafer substrate using a chemical bonding layer to obtain a wafer structure, the film comprising a polymer having a refractive index greater than 1.5; texturing the film to form a plurality of features configured to interact with light; and dicing the wafer structure into a plurality of light shaping optical elements that includes a light shaping optical element having a plurality of features configured to interact with light.

Aspect 17. The method of aspect 16, wherein texturing the film comprises ion etching the film.

Aspect 18. The method of any of aspects 16-17, wherein texturing the film comprises introducing, by lithography, a pattern onto the film after chemically bonding the film to the wafer substrate and before dicing the wafer structure into the plurality of light shaping optical elements.

Aspect 19. The method of any of aspects 16-18, wherein each of the plurality of features has an in-plane dimension less than a thickness of the film.

Aspect 20. The method of aspect any of aspects 16-19, wherein: the wafer substrate has a thickness of greater than 0.1 mm; the film has a thickness of greater than 15 µm; and the chemical bonding layer has a thickness in a range of 0.1 µm and 20 µm.

The foregoing describes only some embodiments, and alterations, modifications, additions and/or changes can be made thereto without departing from the scope and spirit of the disclosed embodiments, the embodiments being illustrative and not restrictive. Furthermore, implementations are not limited to the disclosed embodiments, and may cover various modifications and equivalent arrangements included within the spirit and scope of the disclosed embodiments. Also, the various embodiments described above may be implemented in conjunction with other embodiments, for example, aspects of one embodiment may be combined with aspects of another embodiment to realize yet other embodiments. Further, each independent feature or component of any given assembly or process may constitute an additional embodiment. As used herein, the singular forms of “a,” “an,” and “the” include plural referents unless the context clearly dictates otherwise. In addition, as used herein, the term “or” means “and/or” unless the context clearly dictates otherwise.

What is claimed is:

1. An optical device, comprising:
a light shaping optical element, comprising:
a substrate having a shear modulus greater than 15 GPa; and
a film chemically bonded to the substrate by a chemical bonding layer having a thickness in a range of 0.1 µm and 20 µm,
the film comprising a polymer having a refractive index greater than 1.5,
a surface, of the film, comprising a plurality of features configured to interact with light, and
the film having a thickness of greater than 15 µm.

2. The optical device of claim 1, wherein each of the plurality of features has an in-plane dimension less than the thickness of the film.

3. The optical device of claim 1, wherein the film comprises a single-phase material that includes the polymer.

4. The optical device of claim 1, wherein the light shaping optical element is disposed in at least one of a diffuser, a lens, a micro-lens array, or a polarization controller.

5. The optical device of claim 1, wherein the film is free of oxide nanoparticles.

6. The optical device of claim 1, wherein the polymer comprises a polyimide.

7. The optical device of claim 1, wherein the refractive index of the polymer is greater than 2.

8. The optical device of claim 1, wherein the substrate has a thickness of greater than 0.1 mm.

9. The optical device of claim 1, wherein the polymer has a melting point greater than 400°C.

10. The optical device of claim 1, wherein the polymer has a glass transition temperature greater than 200°C.

11. A wafer structure, comprising:
a substrate; and
a film chemically bonded to the substrate by a chemical bonding layer,
the film comprising a polymer having a refractive index greater than 1.5, and
a surface of the film comprising a plurality of features configured to interact with light.

12. The wafer structure of claim 11, wherein each of the plurality of features has an in-plane dimension less than a thickness of the film.

13. The wafer structure of claim 11, wherein:
the substrate has a shear modulus greater than 15 GPa;
the film has a thickness of greater than 15 µm; and
the chemical bonding layer has a thickness in a range of 0.1 µm and 20 µm.

14. The wafer structure of claim 11, wherein the film is free of oxide nanoparticles.

15. The wafer structure of claim 11, wherein the film comprises a single-phase material that includes the polymer.

16. A method, comprising:
providing a wafer substrate;
chemically bonding a film to the wafer substrate using a chemical bonding layer to obtain a wafer structure, the film comprising a polymer having a refractive index greater than 1.5;
texturing the film to form a plurality of features configured to interact with light; and
dicing the wafer structure into a plurality of light shaping optical elements.

17. The method of claim 16, wherein texturing the film comprises ion etching the film.

18. The method of claim 16, wherein texturing the film comprises introducing, by lithography, a pattern onto the film after chemically bonding the film to the wafer substrate and before dicing the wafer structure into the plurality of light shaping optical elements.

19. The method of claim 16, wherein each of the plurality of features has an in-plane dimension less than a thickness of the film.

20. The method of claim 16, wherein:
the wafer substrate has a shear modulus greater than 15 GPa;
the film has a thickness of greater than 15 µm; and
the chemical bonding layer has a thickness in a range of 0.1 µm and 20 µm.
